(19) United States
(12) Patent Application Publication
(10) Pub. No.: US 2013/0194186 A1
(43) Pub. Date: Aug. 1, 2013

(54) POINTING DEVICE HAVING DIRECTIONAL SENSOR AND NON-DIRECTIONAL SENSOR, AND POINTING DATA INPUT METHOD USING IT

(71) Applicants: Jae Sook Choi, Dongjag-gu (KR); In Kwang Kim, Dongjag-gu (KR); Young Pyo Hong, Deogyang-gu (KR)

(72) Inventors: Jae Sook Choi, Dongjag-gu (KR); In Kwang Kim, Dongjag-gu (KR); Young Pyo Hong, Deogyang-gu (KR)

(73) Assignees: CARDCAM, CO., LTD., Seoul (KR); Jae Sook Choi, Dongjag-gu, Seoul (KR)

(21) Appl. No.: 13/880,217

(22) PCT Filed: Oct. 19, 2011
(86) PCT No.: PCT/KR2011/007788

§ 371 Date: Apr. 18, 2013

(30) Foreign Application Priority Data
Oct. 19, 2010 (KR) 10-2010-0102133

(51) Int. Cl. G06F 3/0354

(52) U.S. Cl. CPC G06F 3/0354
USPC 345/163

(57) ABSTRACT

Provided is a pointing data input method using a pointing device having a directional sensor for inputting pointing data accurately in an intended direction regardless of the bearing of the device, and a non-directional sensor. A device (100) includes DS (110), NDS (120), and a controller (130). The controller (130) controls pointing data on the basis of NDS data, and the pointing data is recognized by the DS (110) and is inputted based on a measured movement direction and distance. The controller (130) includes a comparator (132) for comparing the NDS data with the DS data, a modifier 134 for modifier (134) for modifying the DS data, and a means (136) for outputting the movement direction recognized by the NDS (120) as pointing data.

### BACKGROUND OF THE INVENTION

1. Field of the Invention

The present invention relates to a pointing device such as a mouse or a pen mouse, and a pointing data input method using the pointing device, more specifically, to a pointing device having not only directional sensors but also non-directional sensors so as to allow a user precisely input pointing data in the direction intended by the user with regardless of the azimuth of the pointing device, and a pointing data input method using the pointing device.

2. Description of the Related Art

The pointing device is a general input device that is often used to move a cursor on a display of a computer, or sometimes used to draw a line corresponding to movement of the device, for example.

Typically, the pointing device is provided with an optical sensor consisting of a plurality of light-receiving elements in a grid array of M columns and N rows as shown in FIG. 1. Since the optical sensor may continue to capture images, wherein a single-framed image is formed of M×N pixels, the device recognizes movement of itself by comparing an image with the prior image in pixel level, so that it may be performed either the make movement of a cursor or to enter a stroke to draw a line on a computer display corresponding to the recognized device movement.

Such a grid-arrayed optical sensor, meanwhile, involves directional properties in any way. FIGS. 2A to 2C illustrate examples of the directional properties in associated with the optical sensor. In FIGS. 2A to 3C, there are represented the upward by an arrow U_{T} and the rightward by an arrow U_{R} on a operating plane on which the pointing device is moved by a user, the upward by an arrow S_{T} and the rightward by an arrow S_{R} on the grid array of the optical sensor in the pointing device, and the upward by an arrow D_{T} and the rightward by an arrow D_{R} on a display screen of an associated computer.

FIG. 2A represents successive image frames captured by the optical sensor, and a trajectory of the cursor movement on the screen in associated with the captured image frames, when the pointing device is moved rightwards while the azimuth of the optical sensor is aligned with the azimuth of the operating plane.

FIG. 2B represents successive image frames captured by the optical sensor, and a trajectory of the cursor movement on the screen in associated with the captured image frames, when the pointing device is moved rightwards while the azimuth of the optical sensor is biased left-up from the azimuth of the operating plane.

FIG. 2C represents successive image frames captured by the optical sensor, and a trajectory of the cursor movement on the screen in associated with the captured image frames, when the pointing device is moved rightwards while the azimuth of the optical sensor is biased right-up from the azimuth of the operating plane.

FIG. 3A represents a trajectory of the pointing device movement on the operating plane, and a trajectory of the cursor movement on the screen in associated with the pointing device movement, while the azimuth of the optical sensor is aligned with the azimuth of the operating plane.

FIG. 3B represents a trajectory of the pointing device movement on the operating plane, and a trajectory of the cursor movement on the screen in associated with the pointing device movement, while the azimuth of the optical sensor is biased left-up from the azimuth of the operating plane.

FIG. 3C represents a trajectory of the pointing device movement on the operating plane, and a trajectory of the cursor movement on the screen in associated with the pointing device movement, while the azimuth of the optical sensor is biased right-up from the azimuth of the operating plane.

As shown in FIGS. 2A to 2C and 3A to 3C, it is possible for a user to move a cursor, to draw a line, or to write a character with a pointing device formed of a grid-arrayed optical sensor while the azimuth of the optical sensor is aligned with the azimuth of the operating plane. However, the cursor takes the wrong way to draw a unintended line resulting in making a mess of written character, while the azimuth of the optical sensor is biased from the azimuth of the operating plane.

Although a device such as a mouse or a pen mouse is typically designed to get the azimuth of the optical sensor aligned with the azimuth of the operating plane while a user holds the device comfortably, it is very common to use the device while he/she holds the device in a incorrect manner due to unawareness or inherent habits so that the azimuth of the optical sensor is biased from the azimuth of the operating plane. Sophisticated operations such as sketching or writing are seriously influenced from a minor bias between azimuths of the optical sensor and the operating plane. Especially in the case of a long thin pen mouse, such a bias may be the most likely cause of erroneous operation since the degree of bias may be more enlarged.

Herein, “directional sensor (hereinafter, referred to as “DS”)” collectively denotes any possible sensors such as a grid-arrayed optical sensor, by which a user can input pointing data in his/her intended direction only when the azimuth of the sensor is aligned with the azimuth of the operating plane.

Herein, “non-directional sensor (hereinafter, referred to as “NDS”)” collectively denotes any possible sensors, by which a user can input pointing data in his/her intended direction, i.e., in the direction corresponding to the device moving direction made by the user on the operating plane, regardless of the azimuth of the sensor with respect to the operating plane.

Herein, “operating plane (hereinafter, referred to as “OP”)” means any possible area defined with a length and a width, in which the pointing device may be moved by the user. The user may move the pointing device from left to right along the width direction of the OP if he/she intend to input pointing data having the trajectory from left to right on the display screen of the computer. Similarly, the user may move the pointing device from right to left along the width direction of the OP, from bottom to top, or from top to bottom along the length direction of the OP, respectively, if he/she intend to input pointing data having the trajectory from right to left, from bottom to top, or from top to bottom on the display screen of the computer.

FIG. 4 is a diagram for illustrating an example of inputting moving data using a NDS. In FIG. 4, there are represented the upward by an arrow U_{T} and the rightward by an arrow U_{R} on a OP on which the pointing device is moved by a user, the upward by an arrow S_{T} and the rightward by an arrow S_{R} of the NDS in the pointing device, and the upward by an arrow DT and the rightward by an arrow D_{R} on a display screen of an associated computer.

As shown in FIG. 4, inputting moving data using a NDS allows such moving data to be inputted that the moving data has the direction corresponding to the pointing device moving direction made by the user, regardless of the azimuth of the sensor or the pointing device.

The NDS may be formed from a space sensor such as a tilt sensor, an acceleration sensor, a gyro sensor and so forth.

Such a NDS has the advantage of accurately detecting the device moving direction, but the NDS cannot form such a mouse in alone that precise moving data should be inputted for cursor movement, sketching or writing because the NDS may not recognize the distance of movement of the device, precisely.

### SUMMARY OF THE INVENTION

The present invention is to provide an enhanced pointing device by which the moving direction can be accurately detected and moving data can be precisely inputted.

The present invention is to provide an enhanced pointing device by which a user can easily input a precise pointing data at high speed with a reduced concern of operation failure.

The present invention is to provide an enhanced pointing device by which a user can conduct cursor movement, sketching or writing in his/her intended direction even when the azimuth of the device is not aligned with that of the OP.

The present invention is to provide an enhanced pointing device by which information about a relative direction and distance between strokes can be acquired, the information being important in handwriting operation to realize excellent handwriting recognition processing.

According to an aspect of the present invention, there is provided a pointing device comprising: a directional sensor configured to recognize a first moving direction and to measure a first moving distance of the pointing device; a non-directional sensor configured to recognize a second moving direction of the pointing device independently of the directional sensor; and a controller configured to control pointing data outputted from the pointing device, wherein the pointing data is outputted based on the first moving direction and the first moving distance, the pointing data being controlled on the basis of the second moving direction.

The controller may comprise a comparator configured to compare the second moving direction with the first moving direction, wherein the pointing data may include the first moving direction and the first moving distance when the second moving direction is same with the first moving direction, and wherein the pointing data may include a moving direction other than the first moving direction when the second moving direction is different from the first moving direction.

The controller may comprise a modifier configured to modify the pointing data including the first moving direction and the first moving distance on the basis of the second moving direction, wherein the modified pointing data may include a moving direction and a moving distance modified by the modifier when the second moving direction is different from the first moving direction.

The modifier may be configured to modify the pointing data by replacing the first moving direction with the second moving direction, and by replacing the first moving distance with its component in the second moving direction.

The non-directional sensor may be configured to measure a second moving distance of the pointing device, wherein the comparator may be configured to compare the second moving distance with the first moving distance, and wherein the modifier may be configured to modify the pointing data by replacing the first moving distance with the second moving distance when the second moving distance is larger than the first moving distance.

The pointing device further may comprise means for outputting the second moving direction as the pointing data when the directional sensor does not recognize any moving direction or when the pointing device fails in processing data about the first moving direction.

According to another aspect of the present invention, there is provided a pointing data input method comprising steps for: acquiring a first moving data including a first moving direction recognized by a directional sensor and a first moving distance measured by a directional sensor; acquiring a second moving data including a second moving direction recognized by a non-directional sensor independently of the directional sensor; and controlling pointing data, wherein the pointing data is inputted based on the first moving direction and the first moving distance, the pointing data being controlled on the basis of the second moving direction.

The step for controlling pointing data may comprise a step for comparing the second moving direction with the first moving direction, wherein the pointing data may include the first moving direction and the first moving distance when the second moving direction is same with the first moving direction, and wherein the pointing data may include a moving direction other than the first moving direction when the second moving direction is different from the first moving direction.

The step for controlling pointing data may comprise a step for modifying the pointing data including the first moving direction and the first moving distance on the basis of the second moving direction, wherein the pointing data may include a moving direction and a moving distance modified by the modifier when the second moving direction is different from the first moving direction.

The step for modifying may be configured to modify the pointing data by replacing the first moving direction with the second moving direction and by replacing the first moving distance with its component in the second moving direction.

The step for acquiring the second moving data may be configured to measure a second moving distance of the pointing device, wherein the step for comparing may be configured to compare the second moving distance with the first moving distance, and wherein the step for modifying the pointing data may be configured to modify the pointing data by replacing the first moving distance with the second moving distance when the second moving distance is larger than the first moving distance.

The pointing data input method further may comprise a step for outputting the second moving direction as the pointing data when the directional sensor does not recognize any moving direction or when the pointing device fails in processing data about the first moving direction.

The directional sensor may comprise any one of grid-arrayed optical sensors such as infrared sensors, laser sensors, and so forth, which are used in conventional optical mice.

The non-directional sensor may comprise a spatial sensor such as tilt sensors, acceleration sensors, gyro sensors, and so forth.

With the pointing device configured to control its pointing data on the basis of the second moving direction recognized by the non-directional sensor according to the present invention, even when the azimuth of the device is not aligned with the azimuth of the operating plane, it is possible to input its moving data precisely by recognizing a first moving direction and a first moving distance data by the directional sensor while a correct moving direction is sensed by the non-directional sensor, so that a user can conduct cursor movement, sketching or writing in his/her intended direction, and any likelihood of operation failure can be reduced.

With the pointing data configured to include a moving direction other than the first moving direction recognized by the directional sensor when the second moving direction recognized by the non-directional sensor is different from the first moving direction recognized by the directional sensor, it is possible to input pointing data in the direction corresponding to the moving direction of the device while the azimuth of the device is not aligned with the azimuth of the operating plane.

With the pointing data configured to include a moving direction and a moving distance modified by the modifier when the second moving direction recognized by the non-directional sensor is different from the first moving direction recognized by the directional sensor, it is possible to input pointing data having more correct moving distances and/or moving speeds in the direction corresponding to the moving direction of the device while the azimuth of the device is not aligned with the azimuth of the operating plane.

With the pointing data configured to modify the first moving direction recognized by the directional sensor and the first moving distance measured by the directional sensor by replacing the first moving direction with the second moving direction recognized by the non-directional sensor, and by replacing the first moving distance with its component in the second moving direction acquired by the non-directional sensor, it is possible to input pointing data having even more correct moving distances in the direction corresponding to the moving direction of the device while the azimuth of the device is not aligned with the azimuth of the operating plane.

With the pointing data configured to modify the first moving distance measured by the directional sensor by replacing it with the second moving distance measured by the non-directional sensor when the second moving direction recognized by the non-directional sensor is larger than the first moving direction recognized by the directional sensor, it is possible to realize cursor shift across more long distance and/or pointing data input in more rapid operation.

With the pointing data acquired by the non-directional sensor when the directional sensor does not recognize any moving direction or when the pointing device fails in processing data about the first moving direction, it is possible to shift the cursor rapidly from the current position to a predetermined start point and/or a predetermined pause position such as a corner on a display screen.

### BRIEF DESCRIPTION OF THE DRAWINGS

FIG. 1 is a diagram for illustrating an example of a pixel configuration made of grid-arrayed light-receiving elements used in a pointing device such as a conventional optical mouse;

FIGS. 2A to 2C are diagrams for illustrating the azimuth of grid-arrayed optical sensor associated with cursor movement, in which FIG. 2A shows the case of moving the pointing device rightwards while the azimuth of the optical sensor is aligned with the azimuth of the operating plane, in which FIG. 2B shows the case of moving the pointing device rightwards while the azimuth of the optical sensor is biased left-up from the azimuth of the operating plane, and in which FIG. 2C shows the case of moving the pointing device rightwards while the azimuth of the optical sensor is biased right-up from the azimuth of the operating plane;

FIGS. 3A to 3C are diagrams for illustrating the azimuth of grid-arrayed optical sensor associated with drawing a line, in which FIG. 3A shows a pointing device movement while the azimuth of the optical sensor is aligned with the azimuth of the operating plane, in which FIG. 3B shows a pointing device movement, while the azimuth of the optical sensor is biased left-up from the azimuth of the operating plane, and in which FIG. 3C shows a pointing device movement, while the azimuth of the optical sensor is biased right-up from the azimuth of the operating plane;

FIG. 4 is a diagram for illustrating an example of inputting moving data using a NDS;

FIG. 5 is a block diagram for illustrating a configuration of a pointing device according to a preferred embodiment of the present invention;

FIG. 6 is a flowchart for illustrating an example of inputting pointing data using the pointing device as shown in FIG. 5;

FIG. 7 is a flowchart for illustrating another example of inputting pointing data using the pointing device as shown in FIG. 5;

FIG. 8 is a diagram for illustrating an example of modifying DS data by a modifier;

FIG. 9 is a flowchart for illustrating an example of inputting pointing data in the case of measuring moving distance by a NDS in the pointing device as shown in FIG. 5; and

FIG. 10 is a flowchart for illustrating various preferred usages of the pointing device as shown in FIG. 5.

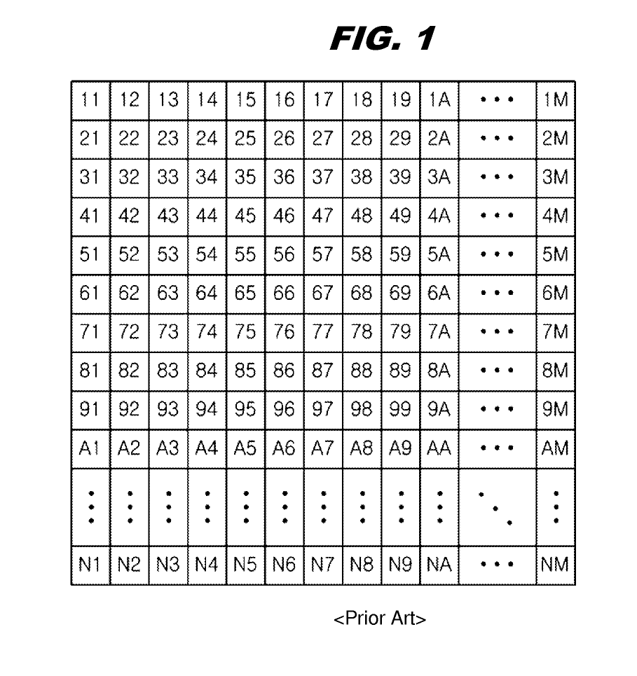

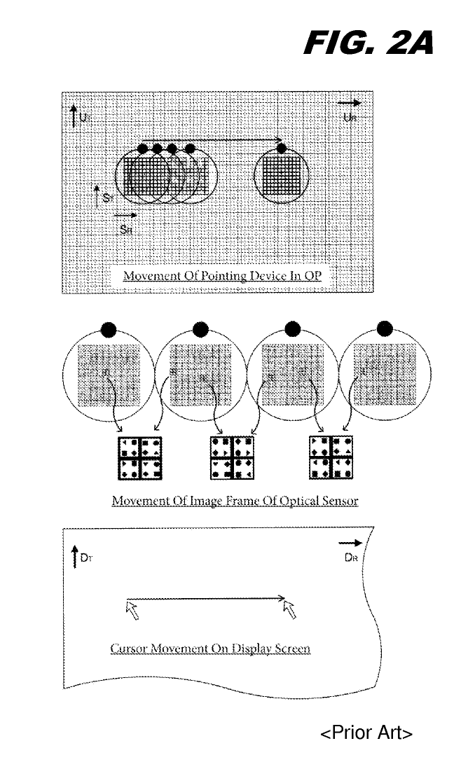

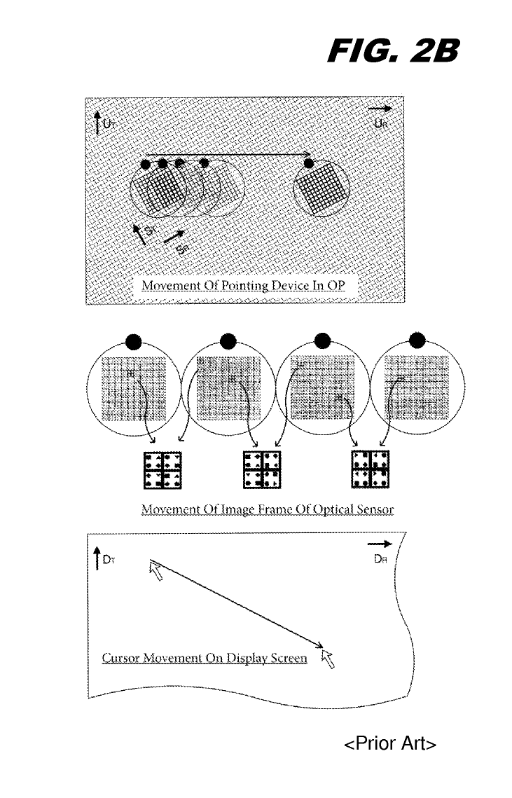

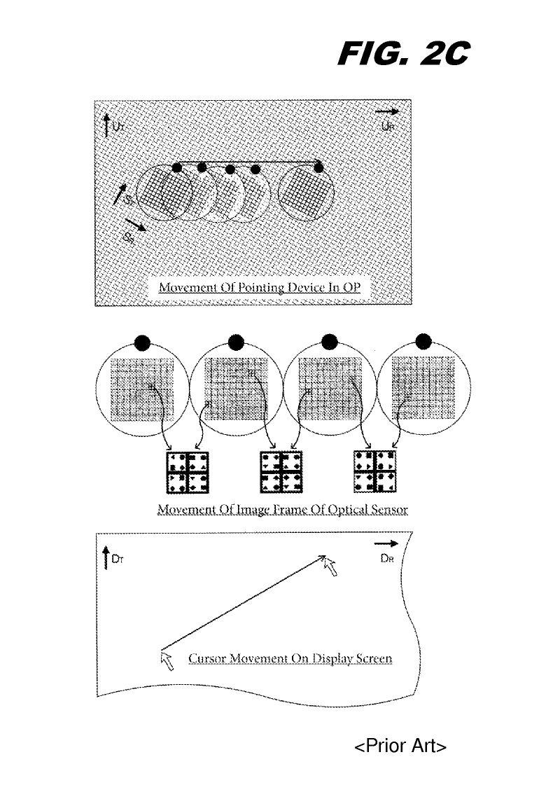

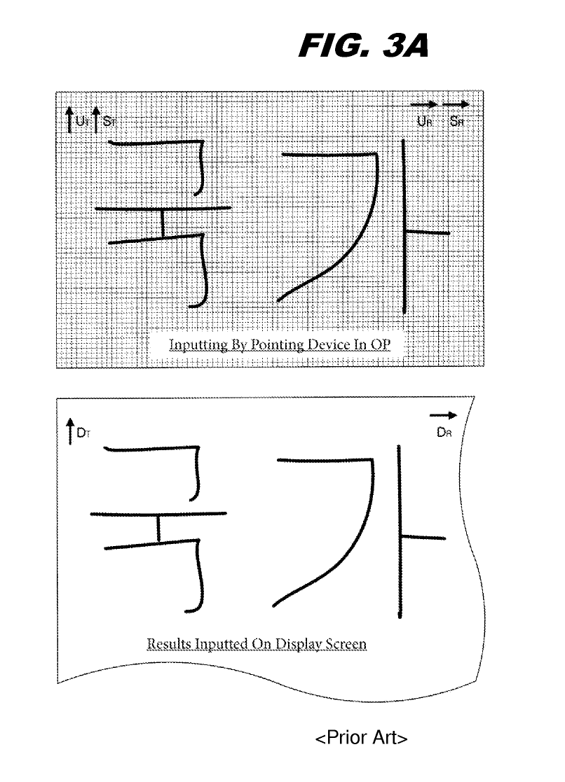

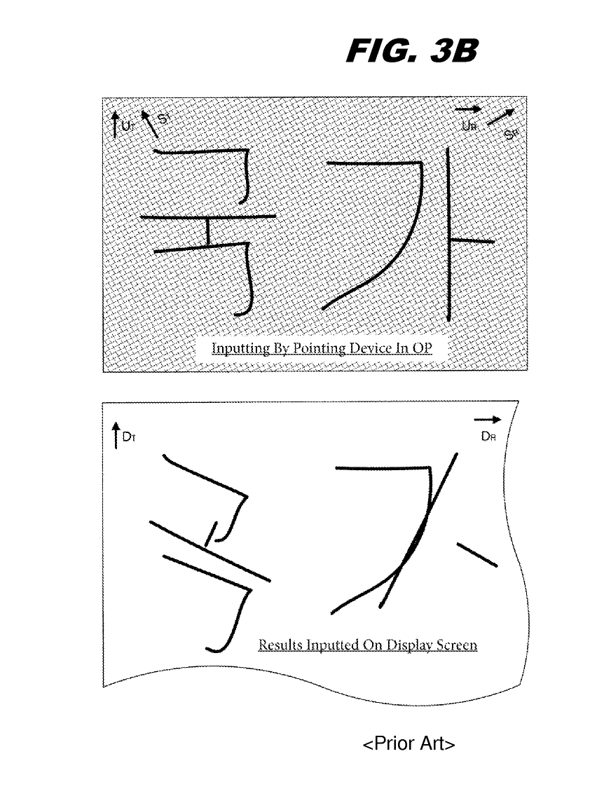

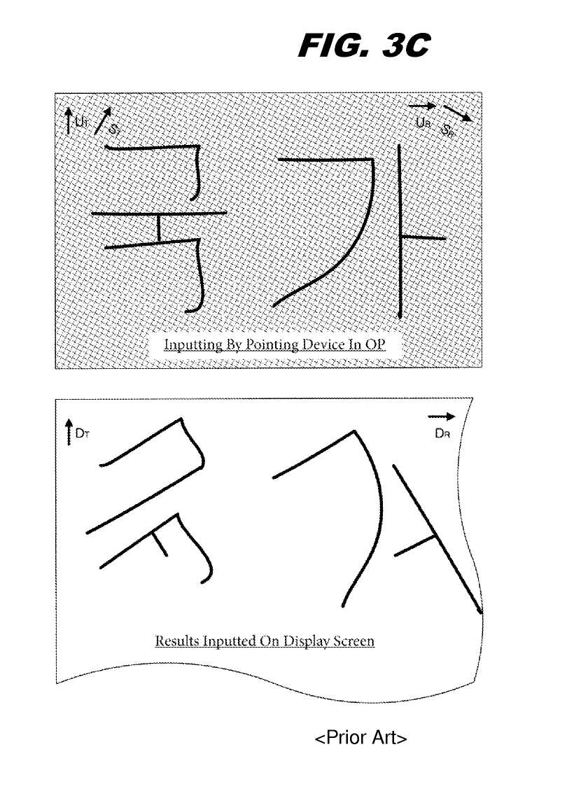

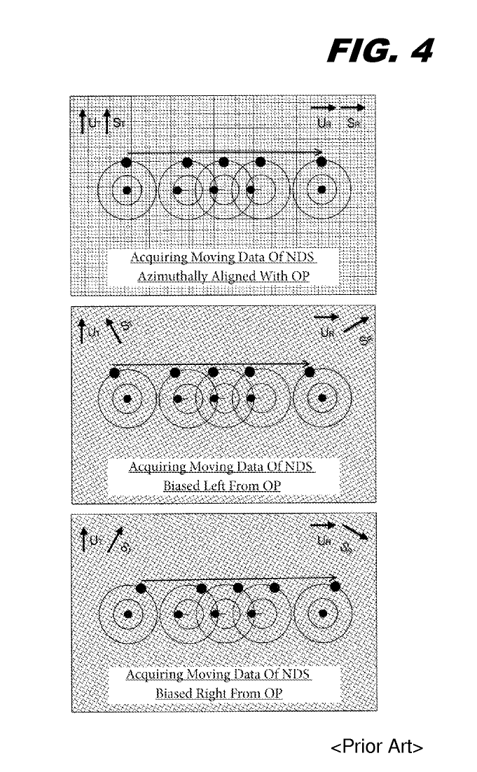

### DETAILED DESCRIPTION OF THE PREFERRED EMBODIMENTS

The configuration of the pointing device and the method of inputting pointing data according to preferred embodiments of the present invention will be described below in detail with reference to the accompanying drawings.

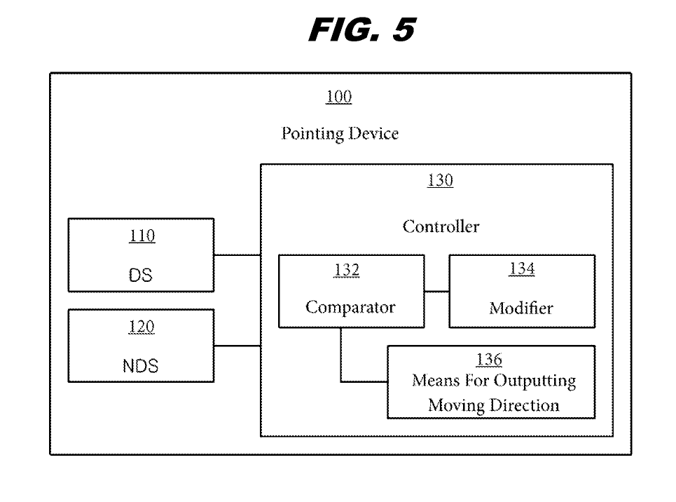

FIG. 5 is a block diagram for illustrating a configuration of a pointing device according to a preferred embodiment of the present invention;

The pointing device 100 includes a DS 110, a NDS 120, and controller 130.

The DS 110 may be a grid-arrayed optical sensor such as an infrared sensor, a laser sensor, etc. used in conventional optical mice. With the DS 110, it is possible for a user to input pointing data in his/her intended direction only when the sensor is aligned azimuthally with an off-hand or on-the-spot OP within which he/she makes movement of the pointing device 100.

The NDS 120 may be a spatial sensor such as a tilt sensor, an acceleration sensor, a gyro sensor, etc. With the NDS 120, it is possible for a user to input pointing data in his/her intended direction regardless of the sensor's azimuth with respect to an off-hand OP within which he/she makes movement of the pointing device 100.

The controller 130 is configured to input pointing data based on the moving direction recognized by the DS 110 and the moving distance measured by the DS 110 while the pointing data is controlled on the basis of the data acquired by the NDS 120.

In addition to the moving direction and the moving distance, the DS 110 may be configured to measure a moving speed. In this case, the moving speed may be controlled on the basis of the data acquired by the NDS 120.

The controller 130 may comprise a comparator 132 for comparing the NDS data with the DS data, and a modifier 134 for modifying the DS data, and, if required, may further comprise means 136 for outputting the moving direction recognized by the NDS 120 as the pointing data.

The configuration and the function of the pointing device 100 along with examples of inputting pointing data using the pointing device 100 will be described below.

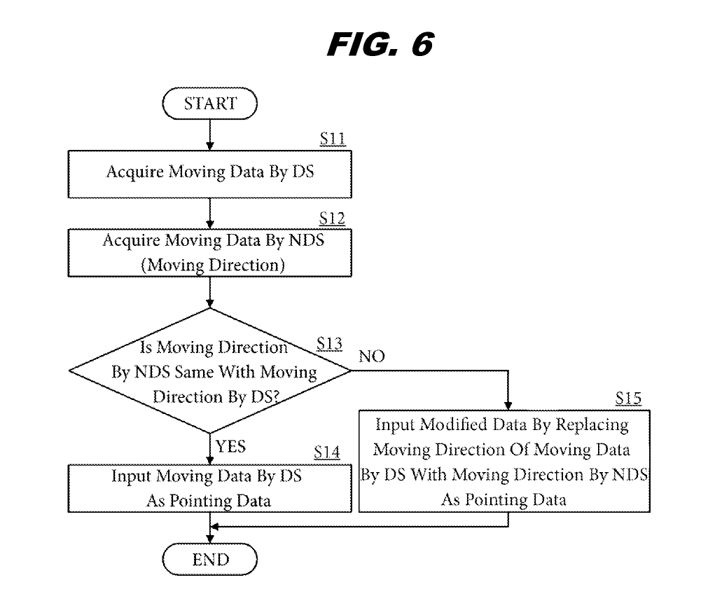

FIG. 6 is a flowchart for illustrating an example of inputting pointing data using the pointing device 100.

With a method of inputting pointing data according to the present invention, a moving direction and a moving distance may be recognized and measured by the DS 110 (step S11), a moving direction may be recognized by the NDS 120 (step S12), and then the pointing data inputted based on the DS data may be controlled on the basis of the NDS data.

If the DS 110 measures a moving speed in addition to the moving direction and the moving distance, the moving speed may be also controlled on the basis of the NDS data.

With the method, the NDS data may be compared with the DS data by the comparator 132 (step S13), and, if the moving direction recognized by the NDS 120 is equivalent with the moving direction recognized by the DS 110, the DS data may be inputted as the pointing data as it is (step S14).

On the other hand, if the moving direction recognized by the NDS 120 is different from the moving direction recognized by the DS 110, the modifier 134 may modify DS data by replacing the moving direction recognized by the DS 110 with the moving direction recognized by the NDS 120 so that the modified DS data is inputted as the pointing data (step S15). In this case, the modifier 134 may not modify the moving distance and/or speed in the DS data to be inputted as the pointing data.

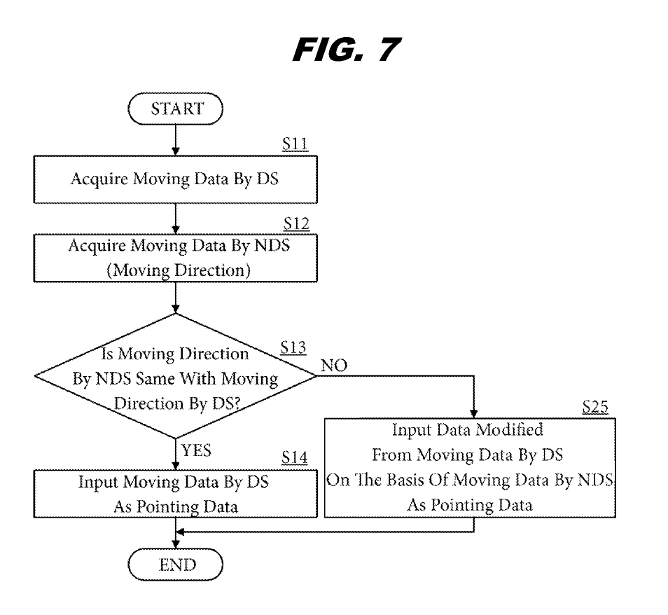

FIG. 7 is a flowchart for illustrating another example of inputting pointing data using the pointing device 100.

According to the method shown in FIG. 7, if the moving direction recognized by the NDS 120 is different from the moving direction recognized by the DS 110, the modifier 134 may modify both the moving direction recognized by the DS 110 and the moving distance measured by the DS 110 so that the modified DS data is inputted as the pointing data (step S25).

If the DS 110 further measures a moving speed, the moving speed may be also modified so that the modified data is inputted as the pointing data.

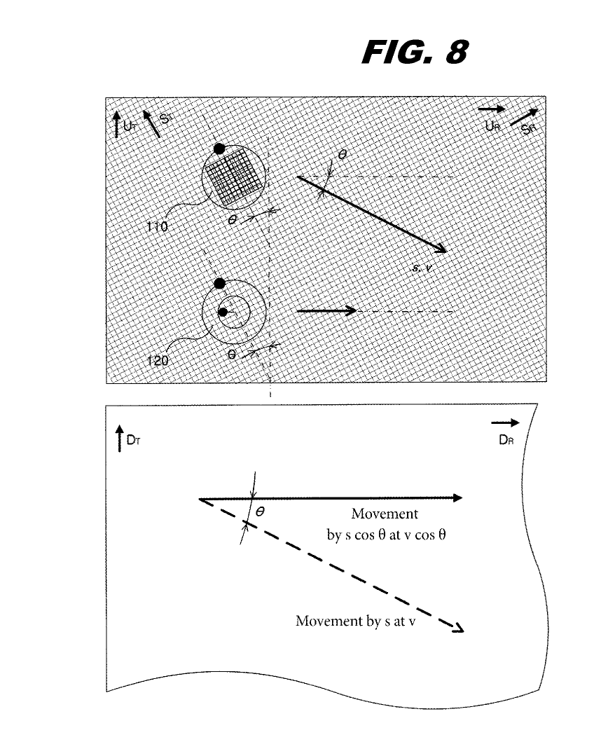

FIG. 8 is a diagram for illustrating an example of modifying DS data by the modifier 134.

In FIG. 8, there are shown the DS data, the NDS data and the pointing data pointing device when the pointing device 100 is moved rightwards in the off-hand OP while the azimuth of the pointing device 100 is biased by an angle 8 from the azimuth of the off-hand OP.

Although the azimuth of the pointing device 100 is biased from the azimuth of the off-hand OP, the moving direction recognized by the NDS 120 corresponds to the moving direction of the pointing device 100, i.e., the rightward in the off-hand OP as shown in FIG. 8.

However, the moving direction recognized by the DS 110 does not correspond to the moving direction of the pointing device 100. Specifically, the recognized moving direction is biased by an angle −θ from the rightward in the off-hand OP.

Without modification of the DS data, in other words, if the DS data is inputted as the pointing data as it is, the resulting pointing data viewed from the display screen should be viewed as if the pointing device 100 is moved by a distance s at a moving speed ν in the direction biased by an angle −θ from the rightward in the off-hand OP while the azimuth of the pointing device 100 is aligned with the azimuth of the off-hand OP as shown by a dotted line in FIG. 8.

With the modification of the moving direction shown in FIG. 8, the moving direction recognized by the DS 110 and biased by an angle −θ from the rightward in the off-hand OP is replaced with the moving direction recognized by the NDS 120, which corresponds to the moving direction of the pointing device 100, i.e., the rightward in the off-hand OP as shown in FIG. 8.

Modification of the moving distance to extract only such a component of the moving distance s recognized by the DS 110 that assumes the same direction with the moving direction recognized by the NDS 120, i.e., the rightward in the off-hand OP. In other words, s cos θ which is modified by the modifier 134 is the moving distance inputted as the pointing data.

Modification of the moving speed to extract only such a component of the moving speed ν recognized by the DS 110 that assumes the same direction with the moving direction recognized by the NDS 120, i.e., the rightward in the off-hand OP. In other words, ν cos θ which is modified by the modifier 134 is the moving speed inputted as the pointing data.

When the pointing data modified by the modifier 134, the resulting pointing data viewed from the display screen should be as if the pointing device 100 is moved by a distance s cos θ at a moving speed ν cos θ in the rightward in the off-hand OP while the azimuth of the pointing device 100 is aligned with the azimuth of the off-hand OP as shown by a solid line in FIG. 8.

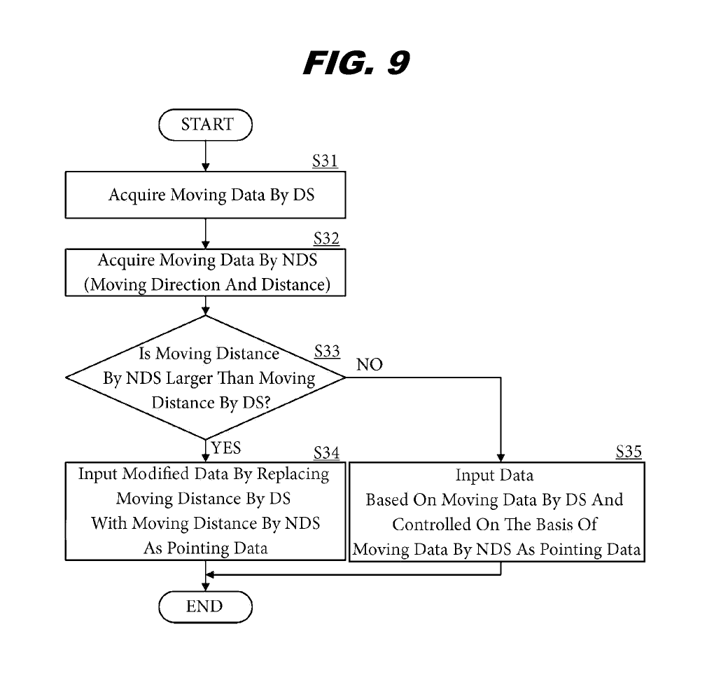

FIG. 9 is a flowchart for illustrating an example of inputting pointing data in the case of measuring also moving distance by a NDS 120 in the pointing device 100.

In this case, a moving direction and a moving distance are recognized and measured by the DS 110 (step S31), another moving distance is measured by the NDS 120 (step S32), and then pointing data inputted based on the DS data is controlled on the basis of the NDS data.

With the method shown in FIG. 9, the moving distance measured by the NDS 120 is compared with the moving distance measured by the DS 110 (step S33). When the moving distance measured by the NDS 120 is larger than the moving distance measured by DS 110, the modifier 134 may modify DS data by replacing the moving distance measured by the DS 110 with the moving distance measured by the NDS 120 so that the modified DS data is inputted as the pointing data (step S34).

When the moving distance measured by the NDS 120 is not larger than the moving distance measured by DS 110, pointing data inputted based on the DS data is controlled on the basis of the NDS data by the controller 130. Data control may be performed as described above in steps S14, S15 and S25.

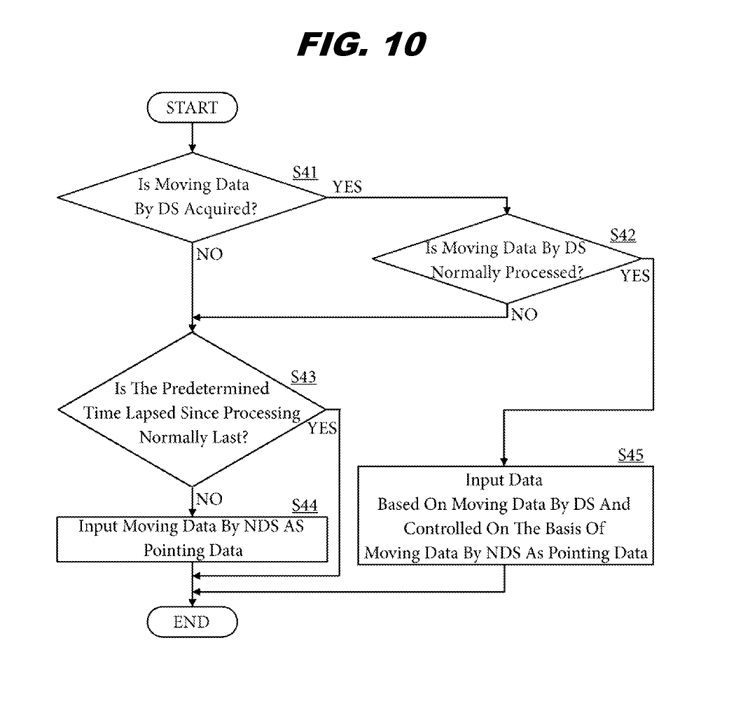

FIG. 10 is a flowchart for illustrating various preferred usages of the pointing device 100.

With the method shown in FIG. 10, which may be used in addition to the methods described above, it is possible to shift the cursor rapidly from the current position to a predetermined start point and/or a predetermined pause position such as a corner on a display screen.

It is monitored whether the DS data is acquired or not (step S41). It is determined whether the DS data is normally processed or not (step S42), and then determined whether a predetermined time is lapsed or not since the acquired DS data was normally processed last (step S43).

In the case that any DS data is not acquired for a while and/or in the case the pointing device fails in processing the DS data, the moving direction recognized by the NDS 120 may be outputted as the pointing data by means 136 for outputting the moving direction before a lapse of the predetermined time (step S44).

In the case that DS data continues to be acquired and the DS data is normally processed, the pointing data is inputted based on the DS data while it is controlled on the basis of the NDS data by the controller 130 as described above.

In the case that any DS data is not acquired for a while and/or in the case that the pointing device fails in processing the DS data, any process for inputting the pointing data may be finished after a lapse of the predetermined time.

When the NDS 120 in the pointing device 100 is a tilt sensor, the moving direction may be recognized on the basis of the inclination of the pointing device 100. When the NDS 120 in the pointing device 100 is an acceleration sensor, the moving distance may be measured on the basis of the acceleration of the pointing device 100.

When the moving direction is recognized on the basis of the inclination of the pointing device 100, the modifier 134 can modify the pointing data by the micro-interval corresponding to the frame speed of the optical sensor of the DS 110, while it may be also possible to modify the pointing data by any long interval. In the case of modifying the pointing data by a long interval, it may be possible to modify the pointing data on the basis of the largest inclination of the pointing device recognized throughout the interval while it may be possible to modify the pointing data on the basis of the average inclination of the pointing device recognized throughout the interval.

It is to be understood that the claims are not limited to the preferred configuration and components illustrated above. Various modifications, changes and variations may be made in the arrangement, operation and details of the devices and methods described herein without departing from the scope of the claims.

What is claimed is:

1. A pointing device comprising:
a directional sensor configured to recognize a first moving direction and to measure a first moving distance of the pointing device;
a non-directional sensor configured to recognize a second moving direction of the pointing device independently of the directional sensor; and
a controller configured to control pointing data outputted from the pointing device,
wherein the pointing data is outputted based on the first moving direction and the first moving distance, the pointing data being controlled on the basis of the second moving direction.

2. The pointing device according to claim 1, wherein the controller comprises a comparator configured to compare the second moving direction with the first moving direction, wherein the pointing data includes the first moving direction and the first moving distance when the second moving direction is same with the first moving direction, and wherein the pointing data includes a moving direction other than the first moving direction when the second moving direction is different from the first moving direction.

3. The pointing device according to claim 2, wherein the controller comprises a modifier configured to modify the pointing data including the first moving direction and the first moving distance on the basis of the second moving direction, wherein the modified pointing data includes a moving direction and a moving distance modified by the modifier when the second moving direction is different from the first moving direction.

4. The pointing device according to claim 3, wherein the modifier is configured to modify the pointing data by replacing the first moving direction with the second moving direction, and by replacing the first moving distance with its component in the second moving direction.

5. The pointing device according to claim 4, wherein the non-directional sensor is configured to measure a second moving distance of the pointing device,
wherein the comparator is configured to compare the second moving distance with the first moving distance, and
wherein the modifier is configured to modify the pointing data by replacing the first moving distance with the second moving distance when the second moving distance is larger than the first moving distance.

6. The pointing device according to claim 5, which further comprises means for outputting the second moving direction as the pointing data when the directional sensor does not recognize any moving direction or when the pointing device fails in processing data about the first moving direction.

7. A pointing data input method comprising steps for:
acquiring a first moving data including a first moving direction recognized by a directional sensor and a first moving distance measured by a directional sensor;
acquiring a second moving data including a second moving direction recognized by a non-directional sensor independently of the directional sensor; and
controlling pointing data, wherein the pointing data is inputted based on the first moving direction and the first moving distance, the pointing data being controlled on the basis of the second moving direction.

8. The pointing data input method according to claim 7, wherein the step for controlling pointing data comprises a step for comparing the second moving direction with the first moving direction, wherein the pointing data includes the first moving direction and the first moving distance when the second moving direction is same with the first moving direction, and wherein the pointing data includes a moving direction other than the first moving direction when the second moving direction is different from the first moving direction.

9. The pointing data input method according to claim 8, wherein the step for controlling pointing data comprises a step for modifying the pointing data including the first moving direction and the first moving distance on the basis of the second moving direction, wherein the pointing data includes a moving direction and a moving distance modified by the modifier when the second moving direction is different from the first moving direction.

10. The pointing data input method according to claim 9, wherein the step for modifying is configured to modify the pointing data by replacing the first moving direction with the second moving direction and by replacing the first moving distance with its component in the second moving direction.

11. The pointing data input method according to claim 10, wherein the step for acquiring the second moving data is configured to measure a second moving distance of the pointing device, wherein the step for comparing is configured to compare the second moving distance with the first moving distance, and wherein the step for modifying the pointing data is configured to modify the pointing data by replacing the first moving distance with the second moving distance when the second moving distance is larger than the first moving distance.

12. The pointing data input method according to claim 11, which further comprises a step for outputting the second moving direction as the pointing data when the directional sensor does not recognize any moving direction or when the pointing device fails in processing data about the first moving direction.
